(19) United States
(12) Patent Application Publication
(10) Pub. No.: US 2004/0054570 A1
(43) Pub. Date: Mar. 18, 2004

(54) System and method for providing logistics planning

(76) Inventor: Jeff Streetman, Plano, TX (US)

Correspondence Address: CARR LAW FIRM, L.L.P., 670 FOUNDERS SQUARE, 900 JACKSON STREET, DALLAS, TX, 75202, US

(21) Appl. No.: 10/243,286

(22) Filed: Sep. 13, 2002

(51) Int. Cl. G06F 17/60

(52) U.S. Cl. 705/8

(57) ABSTRACT

The present invention provides a system and method for consolidating necessary information on one or more shipment orders and generating one or more logistics plans for each shipment order. A computer system having one or more user interfaces is provided to interact with a routing data consolidator and a routing engine. The routing data consolidator is coupled to the computer system and consolidates the shipment information on the shipment orders. The routing data consolidator then generates consolidated shipment information. A routing engine is coupled to the routing data consolidator for receiving the consolidated shipment information on the one or more shipment orders. The routing engine then generates one or more logistics plans for each shipment order by processing the consolidated shipment information.

### BACKGROUND OF THE INVENTION

1. Field of the Invention

The invention relates generally to providing logistics services and, more particularly, to a system and method for managing the delivery of products, items, materials and the like.

2. Description of the Related Art

For many manufacturers, distributors, shippers and others who deliver products and materials of virtually any sort, it is often vital to deliver products, items and materials according to delivery schedules, dates, time-frames, locations and other criteria requested by their existing and prospective outlets, distribution point or networks, customers and the like. In addition, the preferred or necessary manner of transport in making the delivery may vary, depending upon the type of deliverable. For example, certain food products may require refrigeration during transport to avoid spoilage. Other transport or delivery needs, restrictions or preferences might be specified instead of or in addition to the foregoing, depending upon governmental or trade requirements, as well as market, demand, supply, cost and other considerations.

In general, costs associated with a deliverable along the chain of its supply in the marketplace can be reduced if the transport duration is reduced and fewer resources are employed in the delivery. In other words, keeping a delivery vehicle such as a truck, airplane or the like as full as possible and delivering the products they contain as quickly as possible generally results in lower costs associated with the product. Moreover, delivery at the time, at the location, in the manner and as otherwise specified tends to further reduce product costs. Such reduced costs include those directly associated with delivery effort, as well as costs associated with inventory storage, delivery management, product spoilage, lost sales opportunities and the like. Cost reductions often benefit either the suppliers or consumers of a deliverable or preferably both.

Reducing delivery costs tends to dramatically increase the complexity of managing the delivery. This results at least in part from an increasing need to coordinate the delivery of a greater number and variety of products, each according to their associated delivery schedules, locations, preferences and the like with fewer resources. As the complexity increases, further cost reduction becomes more difficult. One aspect of this difficulty is the amount of information about the deliverables and the available delivery chains, such as the path, manner, cost and the like, that must be collected, understood and coordinated in formulating a delivery plan.

Therefore, a need exists for a system and method for reducing cost and increasing efficiency of transporting deliverables.

### SUMMARY OF THE INVENTION

The present invention provides a system and method for consolidating necessary information on one or more shipment orders and generating one or more logistics plans for each shipment order. One or more computer systems having one or more user interfaces are provided. A routing data consolidator is coupled to the one or more computer system for consolidating the shipment information on the one or more shipment orders. The routing data consolidator then generates consolidated shipment information. A routing engine is coupled to the routing data consolidator for receiving the consolidated shipment information on the one or more shipment orders. The routing engine then generates one or more logistics plans for each shipment order by processing the consolidated shipment information.

### BRIEF DESCRIPTION OF THE DRAWINGS

For a more complete understanding of the present invention, and the advantages thereof, reference is now made to the following description taken in conjunction with the accompanying drawings, in which:

FIG. 1 is a block diagram illustrating a routing optimizer system;

FIG. 2A is a first part of a flow diagram illustrating the operation of a routing data consolidator of FIG. 1;

FIG. 2B is a second part of a flow diagram illustrating the operation of a routing data consolidator of FIG. 1; and

FIG. 3 is a flow diagram illustrating the operation of a pallet count function of the routing data consolidator.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

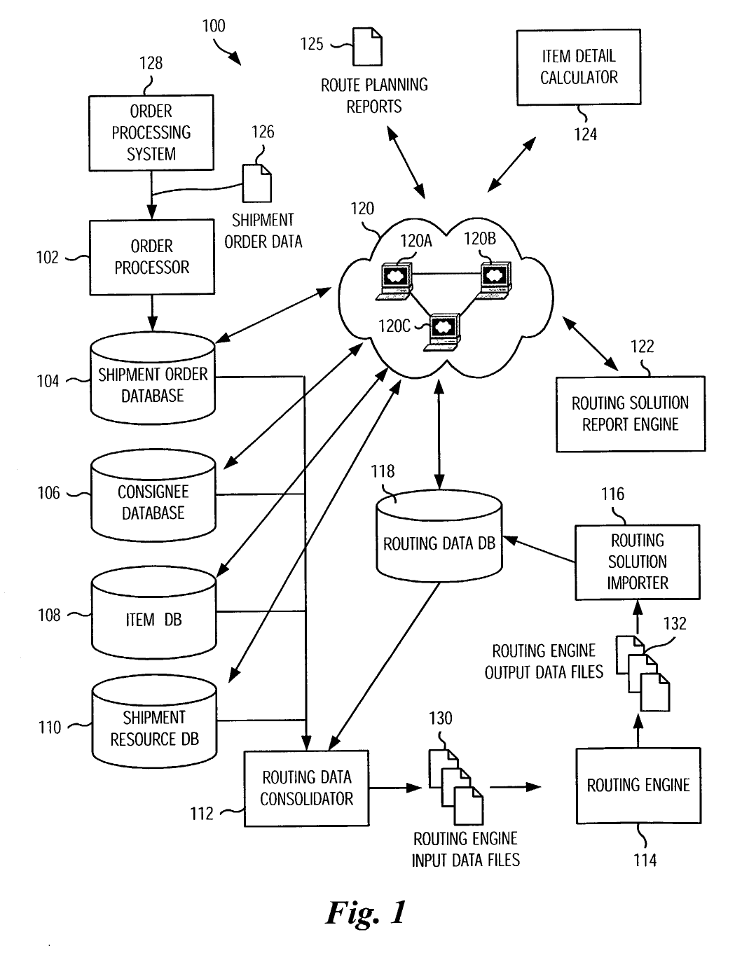

Referring to FIG. 1 of the drawings, the reference numeral 100 generally designates a routing optimizer system in a preferred embodiment of the present invention. The routing optimizer system 100 comprises an order processor 102, a shipment order database 104, a consignee database 106, a item database 108, a shipment resource database 110, a routing data consolidator 112, a routing engine 114, a routing solution importer 116, a routing database 118, a computer network 120, a routing solution report engine 122, an item detail calculator 124, and an routing planning reports 125.

The order processor 102 is configured to receive shipment order data 126 from an order processing system 128. Preferably, the order processing system 128 resides in a shipper's location (not shown). Generally, there could be additional processing system(s) (not shown) for additional shipper(s). In that case, the order processor 102 is configured to receive additional shipment order data (not shown) from such additional order processing system(s), and such additional shipment order data may contain different data for such additional shipper(s). For the sake of simplicity, only the order processing system 128 is described in FIG. 1. However, adding additional order processing system(s) for additional shipper(s) will be apparent from this description.

Preferably, the order processor 102 comprises a first computer system (not shown). Similarly, the order processing system 128 comprises a second computer system (not shown). Both the first and second computer systems may take any form of a computer including but not limited to a desktop computer, a laptop computer, and a handheld computer. The order processor 102 is coupled to the order processing system 128 to receive the shipment order data 126 from the order processing system 128. Wired or wireless communications or any combination thereof may be used to couple the order processor 102 and the order processing system 128.

The order processor 102 is also coupled to the shipment order database 104 to store the shipment order data 126. The shipment order data 126 contains orders from a shipper that are to be routed. Preferably, the shipment order data 126 includes order IDs, shipment pickup location, consignee (i.e., the entity receiving the shipment) identifier, dates and times in which the shipment must be picked up and delivered. Additionally, the shipment order data 126 also contains a list of items in the shipment such as SKU (Stock Keeping Unit) or part number, description, and quantity. The SKU number is the number of one specific product available for sale. If a hardware device or software package comes in different versions, there is an SKU for each one.

The shipment order database 104, the consignee database 106, the item database 108, and the shipment resource database 110 are coupled to the routing data consolidator 112 to provide input data for the routing data consolidator 112.

The consignee database 106 contains a consignee data (not shown). The consignee data includes information about where the shipment is to be shipped. Preferably, the consignee data includes consignee name, address, phone number, fax number, receiving hours and geo-coordinates.

The item database 108 contains an item data (not shown). The item data includes detailed information about all available resources that can be used to move the shipment. Preferably, the item data includes SKU or part number, item description, weight, and item dimensions. Preferably, the consignee and item data is provided by a shipper initially. The data is then maintained and updated within the routing optimizer system 100 electronically or by users using the computer network 120.

The shipment resource database 110 contains a shipment resource data (not shown). The shipment resource data contains detailed information about all available resources that can be used to move the shipment. Preferably, the shipment resource data includes unit identifier, current location, maximum weight capacity, maximum cubic dimension, operational hours, and operational cost. Preferably, the shipment resource data is inputted and updated daily by system operators of the routing optimizer system 100.

Note that disparate databases such as the databases 102, 104, 106, and 110 contain necessary information on one or more shipment orders to generate one or more logistics plans for each shipment order. Although some of these databases may overlap, it is often the case that such necessary information is distributed over different databases. Therefore, it is important to gather all the necessary information so as to automatically generate logistics plan(s) for a shipment order.

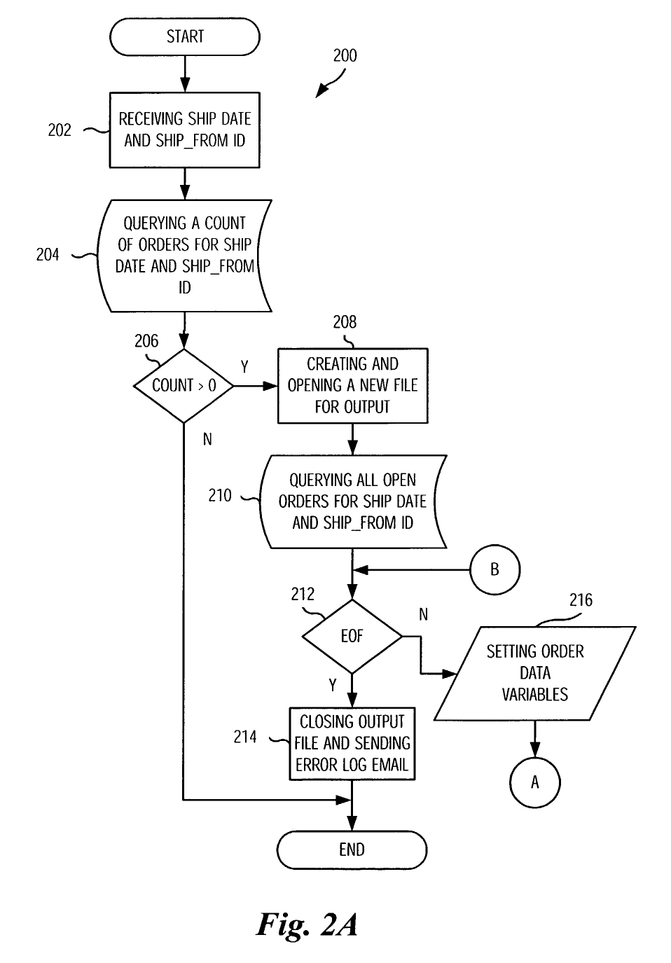

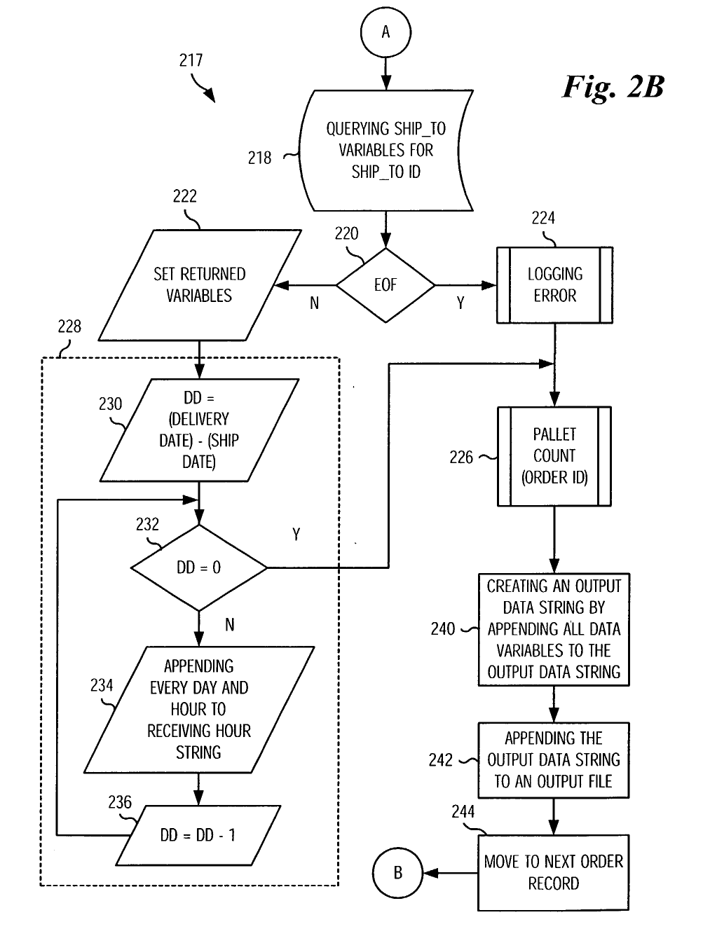

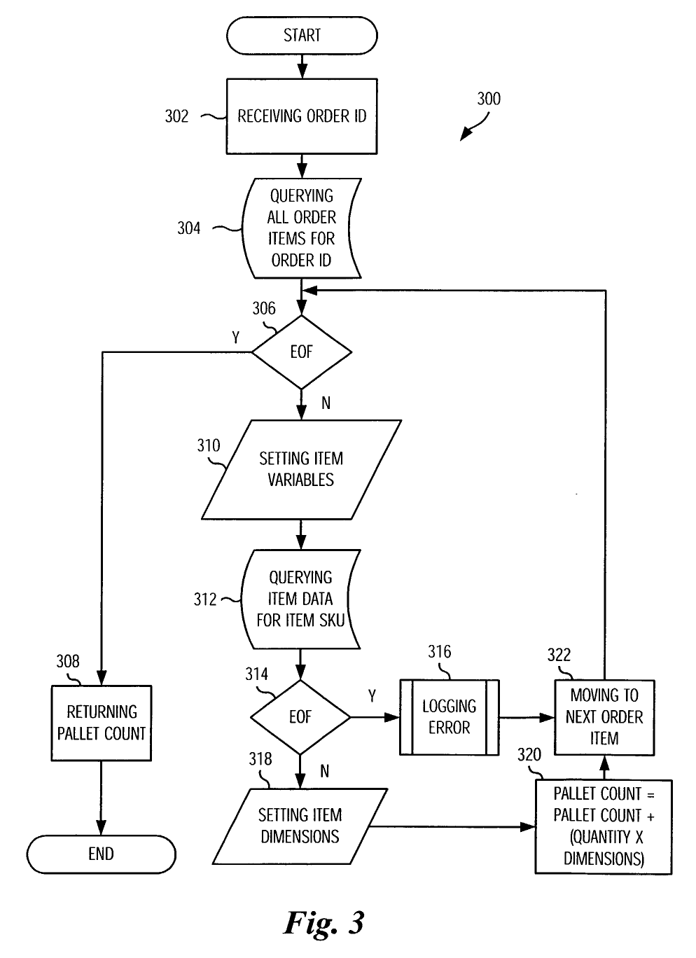

In this respect, the routing data consolidator 112 is coupled to the shipment order database 104, the consignee database 106, the item database 108, and the shipment resource database 110 to receive the shipment order data, the consignee data, the item data, and the shipment resource data, respectively. Preferably, the routing data consolidator 112 is also coupled to the routing data database 118 to receive order IDs (not shown). Alternatively, the routing data consolidator 112 may be coupled directly to the computer network 120. The order ID is a unique identifier for an order that is to be routed. Preferably, the order ID is a combination of an ID generated in the routing optimizer system 100 and an ID generated by the shipper's order processing system 128. The order IDs are automatically queried and consolidated with the shipment order data, the consignee data, the item data, and the shipment resource data. The routing data consolidator 112 generates routing engine input data files 130 to be read by the routing engine 114. Preferably, the routing engine input data files 130 contain all information needed to route and optimize the collection of orders. A more detailed process used in the routing data consolidator is described further below in reference to FIGS. 2 and 3.

The routing engine 114 is configured to generate routing engine output data files 132. The routing engine 132 is a third-party software component that is commercially available. Typically, the routing engine 132 takes all available shipment data inputs in a specific format and uses mathematical algorithms to derive a routing solution. There are several routing engines on the market and each one may use different algorithms and different input formats. The present invention is compatible with such third-party routing engines. The routing solution importer 116 is coupled to the routing engine 114 to receive the routing engine output data files 132. The routing solution importer 116 reads, transforms, and imports the routing engine output data files 132 into the routing data database 118.

The computer network 120 generally comprises one or more computer systems such as computer systems 120A, 120B, and 120C. The computer network 120 is coupled to the routing data database 118, the routing solution report engine 122, the item detail calculator 124, and the route-planning reports 125. Users may access an order pick list (not shown), the routing solution report engine 122, and the item detailed calculator 124 via the computer network 120. Preferably, the order pick list is a graphic user interface (GUI) component of the computer network 120, which interacts with the shipment order database 104, consignee database 106, item database 108, shipment resource database 110, and routing data database 118. The computer network 120 encompasses all the data, security, and user interfaces. Using the computer network 120, users can view and maintain all databases used in the system, view routing solutions, view route-planning reports, and access the order pick list (not shown) to pick one or more orders that are to be routed.

Preferably, users are able to set multiple different values for each order criteria or requirement for a particular shipment order via the computer network 120. In this context, each order criteria is preferably a selected subset of the necessary information on each shipment order. Typically, the order criteria can have a range of values whereas the necessary information other than the order criteria generally has a fix value. The routing optimizer system 100 generates a different logistics plan for each different combination of order criteria for the same shipment order.

For example, a shipment order may be set in the computer network 120 to include differing order criteria such as two or more different shipment pickup locations (e.g., different manufacturing plants or storage facilities or both from which the particular shipment can be shipped) and a plurality of shipping destinations or delivery locations (e.g., different retailer locations). In this example, the routing optimizer system 100 generates a logistics plan for connecting each of the two or more different shipment pickup locations to each of the plurality of shipping destinations. It will be apparent that other criteria may be set with multiple alternatives as well or alternatively. Among the plurality of logistics plans so generated, the user may select a logistics plan that is most cost-effective or otherwise preferable.

Selection of the preferred logistics plan can done by either manual review and selection or automatically. Automatic selection (or filtering) can be accomplished by selecting a primary criteria of selection and identifying the logistics plan resulting in an optimal value of that criteria. In most instances, the optimal value would be the lowest numerical value for that criteria, such as the plan with the lowest number of truck miles, least number of days, lowest cost, and the like. However, it will be apparent that in such instances, it may be desirable to select from the plurality of logistics plans on other bases, such as maximum values of certain criteria or a combination of maximum and minimum values of each of multiple criteria. Alternatively or in addition, a logistics plan may be selected based on one or more criteria falling within or outside a range of values. Note that the computer network 120 may determine the value of the delivery cost criteria by or with reference to the expected travel mileage of a vehicle that delivers the product from a selected shipment pickup location to a selected destination. Generally, a substantially direct relationship exists between such mileage and the actual delivery costs.

In another example, a shipment order may have a lenient delivery date criteria. In other words, the shipment order may have a range of dates on which a product or material are to be delivered to a shipping destination. In this case, the user can set order criteria for this shipment order in the computer network 120 such that the routing optimizer system 100 generates one or more logistics plans to better meet other higher priority or primary criteria other than the delivery date. In one example, the system 100 would generate a separate logistics plan or separate sets of logistics plans (if multiple values of other order criteria were set), for each delivery date within the set ranges of delivery dates. In a manner similar to the previous example, the user may manually or automatically select a logistics plan that is preferred, for example the most cost-effective, from among the one or more logistics plans (including multiple sets of logistics plans) generated.

The user views and picks one or more orders to be routed via the order pick list, which organizes and displays shipment order information and allows the user to selectively choose a collection of orders to be routed. The order IDs of the selected orders are stored in the routing data database 118.

Users can query and organize optimized route plans with a graphical interface via the routing solution report engine 122. The route solution report engine 122 contains all information needed to move the shipment from pickup to delivery. Users can query and view all details of orders to be shipped and calculate weight and space needed for shipments using the item detail calculator 124. The item detail calculator 124 utilizes the same data and computations used in the routing data consolidator 112. cThe route-planning reports 125 are customizable reports that can tell a user virtually everything the user need to know about the optimized routed data that was output by the routing optimizing system 100.

The computer network 120 includes a user interface to route solution report engine 122, item detail calculator 124, and route-planning reports 125. It is a GUI tool that lets users utilize the routing optimizing system 100.

Now referring to FIG. 2A, a flow diagram 200 illustrates a first part of the operation of the routing data consolidator 112 of FIG. 1. The routing data consolidator 112 of FIG. 1 queries all order IDs for a picked ship date and shipped location from the routing data database 118 of FIG. 1. The data is consolidated with the other input data. As described above in reference to FIG. 1, such input data include the shipment order data, the consignee data, the item data along with pallet computations, and the shipment resource data. The routing data consolidator 112 generates a uniquely formatted output file (i.e., the routing engine input data files 130 of FIG. 1) to be read by the routing engine 114 of FIG. 1. The file contains all information needed to route and optimize the collection of orders.

Preferably, the routing data consolidator 112 has the following inputs and outputs:

(1) Ship date (not shown): The routing data consolidator 112 receives an individual ship date or date range for input. Preferably, the ship date is the actual calendar date on which the user chooses to route shipments that are to be shipped.

(2) Ship_from ID (not shown): The routing data consolidator 112 receives the ship_from ID for input. The ship_from ID is a unique identifier in the routing process that identifies a manufacturing plant or storage facility from which the shipments will be shipped.

(3) The routing data consolidator 112 outputs a uniquely formatted output file (i.e., the routing engine input data files 130 of FIG. 1) to be read by the routing engine 114 of FIG. 1. The file contains all information needed to route and optimize the collection of orders.

Alternatively, the inputs to the routing data consolidator 112 may comprise other shipping information as long as such other shipping information is sufficient to identify a particular shipping order.

The routing data consolidator 112 largely comprises a main module and a pallet count sub-function.

In step 202, the routing data consolidator 112 receives shipping information such as the ship date and the ship_from ID.

In step 204, the routing data consolidator 112 queries a count of orders for the ship date and the ship_from ID received in step 202. Specifically, the routing data consolidator 112 queries the shipment order database 104 of FIG. 1 for the count of orders.

In step 206, the routing data consolidator 112 determines whether the order count is larger than 0. If the order count is 0, then the process of the flow diagram 200 is finished. If the order count is larger than 0, then the process goes to step 208.

In step 208, the routing data consolidator 112 creates and opens a new file (not shown) for output.

In step 210, the routing data consolidator 112 queries the shipment order database 104 for all open orders shipping on the inputted ship date and from the inputted ship_from ID.

In step 212, the routing data consolidator 112 determines whether the query in step 210 returns End of File (EOF). If the query returns EOF, then there are no records for orders of the criteria. Thus, in step 214, the routing data consolidator 112 closes the routing engine input data files 130 of FIG. 1, and the process of the flow diagram 200 is finished.

If the query in step 210 does not return EOF in step 212, the routing data consolidator 112 sets all order data variables in step 216. The order data variables, for example, include:

(1) Order ID;

(2) Ship_To ID (Consignee Unique ID);

(3) Ship_To Name;

(4) ship date;

(5) Delivery Date; and

(6) Order Weight.

Now referring to FIG. 2B, a flow diagram 217 illustrates a second part of the operation of the routing data consolidator 112 of FIG. 1.

In step 218, the routing data consolidator 112 queries Ship_To variables for the Ship_To ID from the consignee database 106 of FIG. 1. For example, the Ship_To variables include:

(1) Receiving hours;

(2) Geo-coordinates; and

(3) Address.

In step 220, the routing data consolidator 112 determines whether the query in step 218 returns EOF. If so, the process of the flow diagram 200 goes to step 222. Otherwise, the process goes to step 224.

If the query in step 218 returns EOF, then there is no data for the particular consignee and an error is logged in a routing process error logging routine (not shown), and the process moves on to a pallet count in step 226.

If the query in step 218 does not return EOF, then returned variables (i.e., returned data fields from the query or query results) are set in step 222. Examples of the returned variables include:

(1) Early Receiving Time;

(2) Late Receiving Time;

(3) Latitude Coordinate; and

(4) Longitude Coordinate.

In step 226, the routing data consolidator 112 executes a pallet count function, wherein a pallet count module (not shown) of the routing data consolidator 112 receives the order ID from the routing data database 118 of FIG. 1 and returns a pallet count for the entire order. For a detailed operation of the pallet count function, please refer to the description further below in reference to FIG. 3.

In step 228, the routing data consolidator 112 builds a receiving hour data string by appending the receiving hours for each day that the shipment can be delivered from the ship date to the Delivery Date. Specifically, a variable “DD” is obtained by subtracting the ship date from the Delivery Date in step 230. In Step 232, it is determined whether DD equals 0. If so, the process exits step 228 and goes to step 226. If DD is not 0, then every day and hour is appended to the receiving hour data string. For example, assume that a shipment should be delivered within 3 days of its ship date. In this example, the receiving hour data string must contain the date and receiving hour for each consecutive day from the ship date to the day that it must be delivered, so that the routing engine 114 can use the data to determine the best route based on the days that it can be delivered. Subsequently, DD's value is decremented by 1 in step 236, and the process goes to step 232.

In step 240, the routing data consolidator 112 creates an output data string by appending all variables set previously within the routine. For example, such variables include:

(1) Order ID;

(2) Ship_To ID;

(3) Ship_To name;

(4) Ship_To address;

(5) Ship_To latitude, longitude;

(6) Receiving hour string;

(7) ship date;

(8) Delivery Date;

(9) Order weight; and

(10) Pallet Count.

In step 242, the output data string is appended to an output file such as the routing engine input data files 130 of FIG. 1.

In step 244, the process moves to the next order record and loops back to step 212. When the loop is complete, the output file is closed and the process of the flow diagram 200 is finished.

In FIG. 3, a flow diagram 300 illustrates the operation of the pallet count function described in step 226 of FIG. 2.

In step 302, the routing data consolidator 112 of FIG. 1 receives the order ID from the routing data database 118 of FIG. 1.

In step 304, the routing data consolidator 112 queries all order items from the shipment order database 104 of FIG. 1 for the order ID.

In step 306, the routing data consolidator 112 determines whether the query in step 305 returns EOF. If so, the process of the flow diagram 300 goes to step 308. Otherwise, the process goes to step 310.

In step 308, the routing data consolidator 112 returns a pallet count for the order ID and finishes the pallet count function.

In step 310, the routing data consolidator 112 sets item variables such as item SKU and item quantity.

In step 312, the routing data consolidator 112 queries all item data from the item database 108 of FIG. 1 for the item SKU.

In step 314, the routing data consolidator 112 determines whether the query in step 312 returns EOF. If so, the process of the flow diagram 300 goes to step 316. Otherwise, the process goes to step 318.

In step 316, there is an error, and it is logged in an Error Logger routine (not shown).

In step 318, the routing data consolidator 112 sets item data variables such as quantity per pallet.

In step 320, the routing data consolidator 112 calculates a running pallet count as follows:

Pallet Count=Pallet Count+(Item Quantity×Dimensions)

In step 322, the process moves to the next item SKU in the order and loops back to step 306 (the Open Order Item data query).

The process continues to iterate until the query in step 304 returns EOF. Then, the process is finished, and the pallet count is returned.

It will be understood from the foregoing description that various modifications and changes may be made in the preferred embodiment of the present invention without departing from its true spirit. This description is intended for purposes of illustration only and should not be construed in a limiting sense. The scope of this invention should be limited only by the language of the following claims.

1. A logistics planning system for consolidating necessary information on one or more shipment orders and generating one or more logistics plans for each shipment order, the logistics planning system comprising:
one or more computer systems having one or more user interfaces;
a routing data consolidator coupled to the one or more computer system for consolidating necessary information on the one or more shipment orders and generating consolidated shipment information; and
a routing engine coupled to the routing data consolidator for receiving the consolidated shipment information on the one or more shipment orders and generating one or more logistics plans for each shipment order by processing the consolidated shipment information.

2. The logistics planning system of claim 1, further comprising:
an order processor configured for receiving shipment order data;
a shipment order database coupled to the order processor to receive the shipment order data, coupled to the routing data consolidator to transmit at least part of the shipment order data to the routing data consolidator, and coupled to the one or more computer systems for providing user access to the shipment order data;
a consignee database coupled to the routing data consolidator to transmit consignee data to the routing data consolidator and coupled to the one or more computer systems for providing user access to the consignee data;
an item database coupled to the routing data consolidator to transmit item data to the routing data consolidator and coupled to the one or more computer systems for providing user access to the item data; and
a shipment resource database coupled to the routing data consolidator to transmit shipment resource data to the routing data consolidator and coupled to the one or more computer systems for providing user access to the shipment resource data.

3. The logistics planning system of claim 2, further comprising:
a routing solution importer coupled to the routing engine to receive the routing engine output data and transform the routing engine output data into a transformed routing engine output data, the transformed routing engine output data being reformatted to a format accessible via the one or more computer systems; and
a routing database coupled to the routing solution importer for receiving the transformed routing engine output data and coupled to the one or more computer systems for browsing and processing the transformed routing engine output data via the one or more computer systems and for receiving one or more order IDs from the one or more computer systems, wherein the routing data consolidator retrieves the one or more order IDs from the routing database.

4. The logistics planning system of claim 1, further comprising a routing solution report engine coupled to the one or more computer systems and configured for containing all information needed to move the shipment from pickup to delivery.

5. The logistics planning system of claim 1, further comprising an item detail calculator coupled to the one or more computer systems and configured for enabling a user of the one or more computer systems to query and view all details of orders to be shipped and calculate weight and space needed for shipments.

6. The logistics planning system of claim 1, wherein the one or more computer systems are configured to receive one or more order criteria for each shipment order via the one or more user interface so as to generate optimized necessary information from at least part of the necessary information on the one or more shipment orders.

7. The logistics planning system of claim 6, wherein the optimized necessary information comprises at least one of one or more ship dates, one or more delivery dates, one or more shipping locations, and one or more delivery locations.

8. The logistics planning system of claim 6, wherein the one or more logistics plans are more cost-effective when the optimized necessary information is used.

9. A method for consolidating necessary information on one or more shipment orders and generating one or more logistics plans for each shipment order, the method comprising the steps of:
receiving shipping source information on one or more ship dates and one or more shipping locations for the one or more shipment orders;
querying all open shipment orders among the one or more shipment orders for the shipping source information;
querying one or more shipping destinations related to the shipping source information;
generating receiving hours for each day that a shipment can be delivered from a ship date to a delivery date;
generating a pallet count for each shipment order;
consolidating all data variables for the one or more shipment orders; and
generating one or more logistics plans for the one or more shipment orders.

10. The method of claim 9, further comprising the steps of:
querying a count of orders for the one or more ship dates and the one or more shipping locations;
determining whether the count of orders are larger than zero;
upon determining that the count of orders are larger than zero, creating and opening one or more routing engine input data files; and
upon determining that the count of orders are not larger than zero, ending the method.

11. The method of claim 9, wherein the step of building a receiving hour data string comprises the steps of:
determining a time difference between a ship date and a delivery date for each shipment order;
determining whether the time difference is zero;
upon determining that the time difference is zero, jumping to the step of generating a pallet count for each shipment order;
upon determining that the time difference is not zero, appending every day and hour to a receiving hour string; and
decrementing the value of the time difference by one and jumping to the step of determining whether the time difference is zero.

12. The method of claim 9, further comprising the steps of:
in response to the step of querying one or more shipping destinations related to the shipping source information, determining whether the query returns an end-of-file (EOF) message;
upon determining that the query does not return an EOF message, setting returned variables including a receiving hour string and jumping to the step of building a receiving hour data string; and
upon determining that the query returns an EOF message, logging error and jumping to the step of generating a pallet count for each shipment order.

13. The method of claim 9, wherein the step of generating a pallet count for each shipment order comprises the steps of:
receiving an order identifier for an shipment order;
querying all order items for the order identifier;
in response to the step of querying all order items for the order identifier, determining whether the query returns an end-of-file (EOF) message;
upon determining that the query of all order items for the order identifier returns an EOF message, returning a pallet count and ending the step of generating a pallet count for each shipment order;
upon determining that the query of all order items for the order identifier does not return an EOF message, setting item variables for the order identifier;
querying item data for an item SKU;
in response to the step of querying item data for an item SKU, determining whether the query returns an EOF message;
upon determining that the query of item data for an item SKU returns an EOF message, logging error and moving to a next order item; and
upon determining that the query of item data for an item SKU does not return an EOF message, calculating a pallet count and moving to the next order item.

14. The method of claim 9, further comprising the steps of:
receiving one or more order criteria for each shipment order; and
generating optimized necessary information from at least part of the necessary information on the one or more shipment orders.

15. The method of claim 14, wherein the optimized necessary information comprises at least one of one or more ship dates, one or more delivery dates, one or more shipping locations, and one or more delivery locations.

16. The method of claim 14, wherein the one or more logistics plans are more cost-effective when the optimized necessary information is used.

17. A computer program product for consolidating necessary information on one or more shipment orders and generating one or more logistics plans for each shipment order, the computer program product having a medium with a computer program embodied thereon, the computer program comprising:
computer program code for receiving shipping source information on one or more ship dates and one or more shipping locations for the one or more shipment orders;
computer program code for querying all open shipment orders among the one or more shipment orders for the shipping source information;
computer program code for querying one or more shipping destinations related to the shipping source information;
computer program code for generating receiving hours for each day that a shipment can be delivered from a ship date to a delivery date;
computer program code for generating a pallet count for each shipment order;
computer program code for consolidating all data variables for the one or more shipment orders; and
computer program code for generating one or more logistics plans for the one or more shipment orders.

18. The computer program product of claim 17, the computer program further comprising:
computer program code for querying a count of orders for the one or more ship dates and the one or more shipping locations;
computer program code for determining whether the count of orders are larger than zero;
computer program code for, upon determining that the count of orders are larger than zero, creating and opening one or more routing engine input data files; and
computer program code for, upon determining that the count of orders are not larger than zero, ending the method.

19. The computer program product of claim 17, wherein the computer program code for building a receiving hour data string comprises:
computer program code for determining a time difference between a ship date and a delivery date for each shipment order;
computer program code for determining whether the time difference is zero;
computer program code for, upon determining that the time difference is zero, jumping to the step of generating a pallet count for each shipment order;
computer program code for, upon determining that the time difference is not zero, appending every day and hour to a receiving hour string; and
computer program code for decrementing the value of the time difference by one and jumping to the step of determining whether the time difference is zero.

20. The computer program product of claim 17, the computer program further comprising:
computer program code for, in response to the step of querying one or more shipping destinations related to the shipping source information, determining whether the query returns an end-of-file (EOF) message;
computer program code for, upon determining that the query does not return an EOF message, setting returned variables including a receiving hour string and jumping to the step of building a receiving hour data string; and
computer program code for, upon determining that the query returns an EOF message, logging error and jumping to the step of generating a pallet count for each shipment order.

21. The computer program product of claim 17, wherein the computer program code for generating a pallet count for each order ID comprises:
computer program code for receiving an order identifier for an shipment order;
computer program code for querying all order items for the order identifier;
computer program code for, in response to the step of querying all order items for the order identifier, determining whether the query returns an end-of-file (EOF) message;
computer program code for, upon determining that the query of all order items for the order identifier returns an EOF message, returning a pallet count and ending the step of generating a pallet count for each shipment order;
computer program code for, upon determining that the query of all order items for the order identifier does not return an EOF message, setting item variables for the order identifier;
computer program code for querying item data for an item SKU;
computer program code for, in response to the step of querying item data for an item SKU, determining whether the query returns an EOF message;
computer program code for, upon determining that the query of item data for an item SKU returns an EOF message, logging error and moving to a next order item; and
computer program code for, upon determining that the query of item data for an item SKU does not return an EOF message, computer program code for calculating a pallet count and moving to the next order item.

22. The computer program product of claim 17, further comprising:
computer program code for receiving one or more order criteria for each shipment order; and
computer program code for generating optimized necessary information from at least part of the necessary information on the one or more shipment orders.

23. The method of claim 22, further, wherein the optimized necessary information comprises at least one of one or more ship dates, one or more delivery dates, one or more shipping locations, and one or more delivery locations.

24. The logistics planning system of claim 22, wherein the one or more logistics plans are more cost-effective when the optimized necessary information is used.
